(19) United States
(12) Patent Application Publication
(10) Pub. No.: US 2021/0112194 A1
(43) Pub. Date: Apr. 15, 2021

(54) METHOD AND DEVICE FOR TAKING GROUP PHOTO

(71) Applicant: SZ DJI TECHNOLOGY CO., LTD., Shenzhen (CN)

(72) Inventors: Jie QIAN, Shenzhen (CN); Zhengzhe LIU, Shenzhen (CN); Qifeng WU, Shenzhen (CN)

(21) Appl. No.: 17/106,995

(22) Filed: Nov. 30, 2020

Related U.S. Application Data
(63) Continuation of application No. PCT/CN2018/088997, filed on May 30, 2018.

(51) Int. Cl. H04N 5/232; G06F 3/01; H04N 13/207; H04N 5/225; G06K 9/00; G05D 1/00; G05D 1/10

(52) U.S. Cl. CPC H04N 5/23218; G06F 3/017; H04N 5/23203; H04N 5/23299; G05D 1/106; H04N 5/23245; H04N 5/2253; G06K 9/00664; G05D 1/0094; H04N 13/207

(57) ABSTRACT

A method for taking group photo includes entering a group photo mode based on a trigger instruction, identifying a plurality of targets in a current imaging frame in the group photo mode, and triggering a camera carried by an unmanned aerial vehicle (UAV) to shoot in response to determining a plurality of condition satisfying targets among the plurality of targets. The plurality of condition satisfying targets are ones of the plurality of targets that meet an imaging trigger condition.

### CROSS-REFERENCE TO RELATED APPLICATION

This application is a continuation of International Application No. PCT/CN2018/088997, filed on May 30, 2018, the entire content of which is incorporated herein by reference.

### TECHNICAL FIELD

The present disclosure relates to the field of imaging and, more specifically, to a method and device for taking group photo.

### BACKGROUND

When taking a group photo, a photographer is needed to obtain a more ideal group photo by constantly adjusting the position. This imaging method is troublesome and the imaging angle is relatively limited. With the development of aerial photography in unmanned aerial vehicle (UAV) technology, UAV imaging is being used to replace manual imaging, and the imaging angle is more flexible. However, in conventional technology, there are limited extensive researches on taking group photos using UAVs.

### SUMMARY

In accordance with the disclosure, there is provided a method for taking group photo including entering a group photo mode based on a trigger instruction, identifying a plurality of targets in a current imaging frame in the group photo mode, and triggering a camera carried by an unmanned aerial vehicle (UAV) to shoot in response to determining a plurality of condition satisfying targets among the plurality of targets. The plurality of condition satisfying targets are ones of the plurality of targets that meet an imaging trigger condition.

Also in accordance with the disclosure, there is provided a device for taking group photo including a memory storing program instructions and a processor configured to execute the program instructions to enter a group photo mode based on a trigger instruction, identify a plurality of targets in a current imaging frame in the group photo mode, and trigger a camera carried by an unmanned aerial vehicle (UAV) to shoot in response to determining a plurality of condition satisfying targets among the plurality of targets. The plurality of condition satisfying targets are ones of the plurality of targets that meet an imaging trigger condition.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a diagram showing an application scenario of a method for taking group photo according to an embodiment of the present disclosure.

FIG. 2 is a flowchart of a method for taking group photo according to an embodiment of the present disclosure.

FIG. 3 is a flowchart of a method for taking group photo according to another embodiment of the present disclosure.

FIG. 4 is a diagram showing another application scenario of the method for taking group photo according to an embodiment of the present disclosure.

FIG. 5 is a flowchart of a method for taking group photo according to another embodiment of the present disclosure.

FIG. 6 is a block diagram of a device for taking group photo according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The method and device for taking group photo consistent with the present disclosure will be described in detail below with reference to the drawings. In the case where there is no conflict between the exemplary embodiments, the features of the following embodiments and examples may be combined with each other.

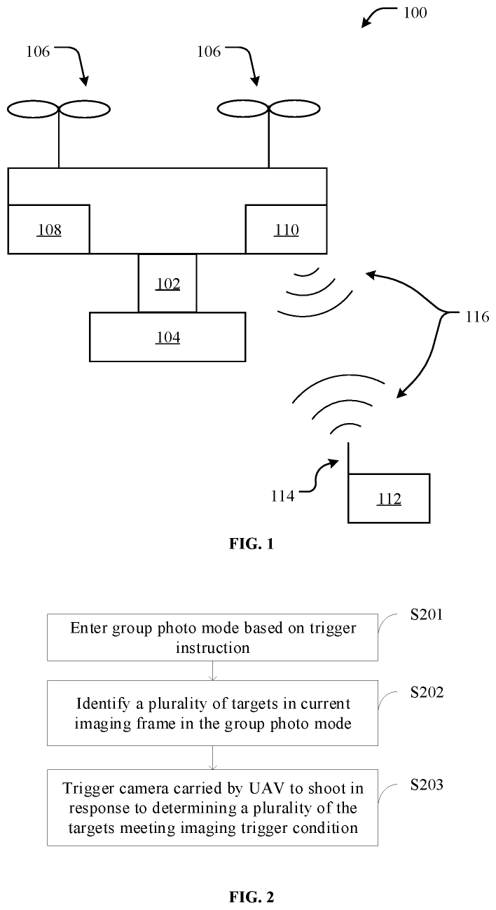

The method for taking group photo consistent with the present disclosure can be applied to UAVs. Refer to FIG. 1, a UAV 100 includes a carrier 102 and a payload 104. In some embodiments, the payload 104 may be directly positioned on the UAV 100 without the carrier 102. In this embodiment, the carrier 102 includes a gimbal, such as a two-axis gimbal or a three-axis gimbal. The payload 104 may be an image acquisition device or an image record device (e.g., a camera, a camcorder, an infrared imaging device, an ultraviolet imaging device, or the like), an audio capturing device (e.g., a parabolic reflective microphone), an infrared imaging device, etc. The payload 104 may provide static sensing data (such as images) or dynamic sensing data (such as videos). The payload 104 may be carried by the carrier 102, such that the payload 104 may be controlled to rotate through the carrier 102. In this embodiment, the carrier 102 is being described as a gimbal and the payload 104 is being described as a camera as examples.

The UAV 100 further includes a power mechanism 106, a sensing system 108, and a communication system 110. In some embodiments, the power mechanism 106 may include one or more rotatable bodies, propellers, blades, motors, electronic speed controllers, and/or the like. For example, the rotatable body of the power mechanism may be a self-tightening rotatable body, a rotatable body assembly, or another rotatable body power unit. The UAV 100 may have one or more power mechanisms and all the power mechanisms may be of the same type. In some embodiments, one or more of the power mechanisms may be of different types. The power mechanism 106 may be mounted to the UAV by suitable means, such as through a support element (such as a drive shaft). The power mechanism 106 may be mounted in any suitable position of the UAV 100, such as the top, bottom, front, back, side, or any combination thereof. The flight of the UAV 100 can be controlled by controlling one or more power mechanisms 106.

The sensing system 108 may include one or more sensors to sense the spatial orientation, velocity and/or acceleration (e.g., relative to the rotation and translation of up to 3 degrees of freedom) of the UAV 100. The one or more sensors may include GPS sensors, motion sensors, inertial sensors, proximity sensors, or image sensors. The sensing data provided by the sensing system 108 may be used to track the spatial orientation, velocity and/or acceleration of a target (as described below, using a suitable processing unit and/or control unit). In some embodiments, the sensing system may also be used to collect environmental data on the UAV, such as climatic conditions, potential obstacles about to be approached, location of the geographic features, location of the man-made structures, and the like.

The communication system 110 enables communication with a terminal 112 having a communication system 114 via wireless signals 116. The communication systems 110 and 114 may include any number of transmitters, receivers, and/or transceivers suitable for wireless communication. The communication may be one-way communication, such that data can be transmitted in only one direction. For example, one-way communication may involve only the UAV 100 transmitting data to the terminal 112, or vice-versa. The data may be transmitted from one or more transmitters of the communication system 110 to one or more receivers of the communication system 112, or vice-versa. In some other embodiments, the communication may be two-way communication, such that data can be transmitted in both directions between the UAV 100 and the terminal 112. The two-way communication can involve transmitting data from one or more transmitters of the communication system 110 to one or more receivers of the communication system 114, and vice-versa.

In some embodiments, the terminal 112 may provide control data to one or more of the UAV 100, the carrier 102, and the payload 104, and receive information (such as the position and/or movement information of the UAV, the carrier, or the payload, the data sensed by the payload, such as the image data captured by the camera) from one or more of the UAV 100, the carrier 102, and the payload 104.

In some embodiments, the UAV 100 may communicate with other remote devices other than the terminal 112, and the terminal 112 may also communicate with other remote devices other than the UAV 100. For example, the UAV and/or terminal 112 may communicate with another UAV or the carrier or payload of another UAV. When needed, the additional remote device may be a second terminal or other computing devices (such as computers, desktop computers, tablets, smart phones, or other mobile devices). The remote device may transmit data to the UAV 100, receive data from the UAV 100, transmit data to the terminal 112, and/or receive data from the terminal 112. In some embodiments, the remote device may be connected to the Internet or other telecommunication networks, such that the data received from the UAV 100 and/or the terminal 112 can be uploaded to a website or a server.

In some embodiments, the movement of the UAV 100, the movement of the carrier 102, the movement of the payload 104 relative to a fixed reference object (such as the external environment), and/or the movement between each other may all be controlled by the terminal 112. The terminal 112 may be a remote control terminal, which is located away from the UAV, the carrier, and/or the payload. The terminal 112 may be positioned at or attached to a supporting platform. In some embodiments, the terminal 112 may be handheld or wearable. For example, the terminal 112 may include a smart phone, a laptop, a desktop computer, a computer, glasses, gloves, a helmet, a microphone, or any combination thereof. The terminal 112 may include a user interface, such as a keyboard, a mouse, a joystick, a touch screen, or a display. Any suitable user input can interact with the terminal 112, such as manual input of instructions, voice control, gesture control, or position control (such as through the movement, position, or inclination of the terminal 112).

FIG. 2 is a flowchart of a method for taking group photo according to an embodiment of the present disclosure. The method will be described in detail below.

S201, entering a group photo mode based on a trigger instruction.

The process at S201 may be performed before the UAV 100 flies or during the flight of the UAV 100. For example, in one embodiment, the process at S201 may be performed before the UAV 100 flies. The user may send a trigger instruction to the UAV 100 by operating on the terminal, or generate a/ci by operating a button on the UAV 100, thereby triggering the UAV 100 to enter the group photo mode.

In another embodiment, the process at S201 may be performed during the flight of the UAV 100, and the trigger instruction may be determined by the target identified by the UAV 100 and the target's attitude (such as a gesture). Take gestures as an example, the UAV 100 switching to the group photo mode during flight may include two situations.

In the first situation, when the distance from the UAV 100 to the target is less than or equal to a predetermined distance (e.g., 5 m), the trigger instruction may be determined by the target's gesture. The trigger instruction received by the UAV 100 may be that the UAV 100 identifies that the target's gesture is a specific gesture, such as a “peace” gesture, a “thumb-up” gesture, etc. In some embodiments, the target may include a gesture controller of the UAV 100, the first target imaged by the camera after the UAV 100 is powered on, and may also include a cluster identified based on the gesture controller of the UAV 100 or the first target.

In the second situation, when the distance from the UAV 100 to the target is greater than the predetermined distance, the trigger instruction may be jointly determined by the target and the target's gesture. In some embodiments, the trigger instruction may be that the UAV 100 identifies a cluster based on the target, and the number of targets in the group in a specific gesture is greater than or equal to a predetermined number.

S202, identifying a plurality of targets in a current imaging frame in the group photo mode.

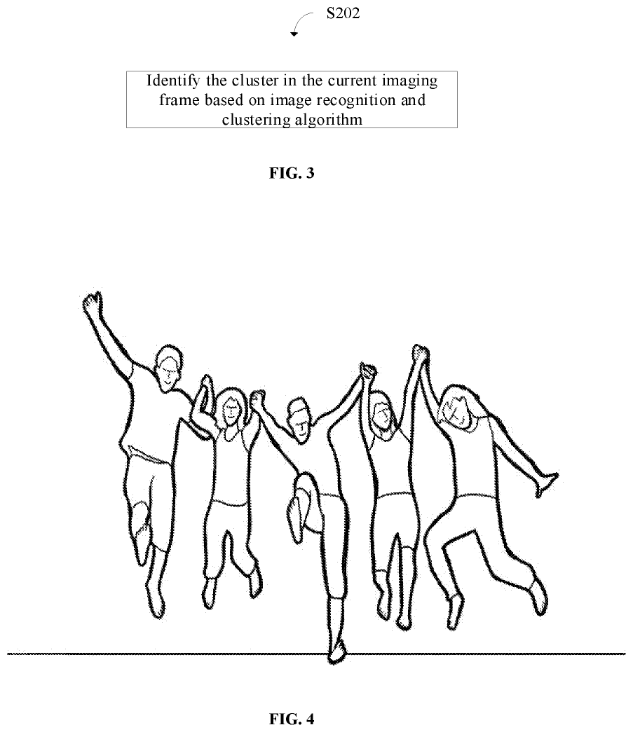

In this embodiment, the UAV 100 may use an algorithm to identify a plurality of targets in the current imaging frame. In one implementation, as shown in FIG. 3, the process at S202 may include identifying the clusters in the current imaging frame based on the image recognition and clustering algorithm. It should be noted that, in this embodiment, the cluster may refer to a group of multiple targets that are close (the distance may be determined based on experience), and whose speed (i.e., the movement speed) and direction (which may include the target's face orientation, movement direction, etc.) that are approximately the same.

In this embodiment, the cluster is the cluster where the specific target is located. In one embodiment, the specific target may be the first target in the cluster captured by the camera after the UAV 100 is powered on. In this embodiment, the first target identified by the camera is used as the main target. The first target captured may be tracked based on image recognition, and other targets that are relatively close to the first target with approximately the same speed and direction may be automatically included based on a clustering algorithm to form a cluster.

In another embodiment, the specific target may also be the gesture controller of the UAV 100. This embodiment takes the gesture controller as the main target. The gesture controller may be tracked based on image recognition, and other targets that are relatively close to the gesture controller and with substantially the same speed and direction may be automatically included based on a clustering algorithm to form a cluster.

In another embodiment, the terminal may receive the imaging frame transmitted by the UAV 100, and the user may directly select a certain target in the imaging frame as the specific target by operating on the terminal. After the user selects the specific target, the specific target may be used as the main target. The specific target may be tracked based on image recognition, and other targets that are relatively close to the specific target with substantially the same speed and direction may be automatically included based on a clustering algorithm to form a cluster. Of course, the user may also directly select multiple targets in the imaging frame as the cluster by operating on the terminal.

In this embodiment, any suitable image recognition algorithm may be used to identify the target, for example, a face recognition algorithm. Of course, in other embodiments, the target may also be identified by means of QR codes, GPS, infrared light, etc.

In addition, the cluster of this embodiment may be changeable. For example, after a cluster is generated, based on the coordinates (i.e., the coordinates of the cluster in the imaging frame may be an average coordinates of the coordinates of each target in the cluster, or the coordinates of the main target in the cluster) and speed of the cluster, the targets that are relatively close and whose speed and direction are substantially the same as those of the cluster may be included in the cluster. Of course, based on the coordinates and speed of the cluster, the targets in the current cluster that are far from other targets and whose speed and direction are far from the other target may be automatically eliminated.

S203, triggering the camera carried by the UAV 100 to shoot in response to determining a plurality of targets meeting an imaging trigger condition. A target meeting the imaging trigger condition is also referred to as a “condition satisfying target.”

This embodiment uses image recognition to trigger the group photo function. Compared with the conventional methods that use voice, mechanical switches, and the user's handheld lights to trigger the group photo function, the composition of the image captured by this embodiment is richer and more professional.

In the process at S203, determining that a plurality of target meet the imaging trigger condition may include determining that the targets in the specific attitude in the cluster is greater than or equal to the predetermined number. In some embodiments, the predetermined number may be a fixed number, such as 3 or 5, or it can be set as a certain ratio of the number of targets in the cluster, such as 1/2. The specific attitude may include many types, in some embodiments, determining that the target is in a specific attitude may include determining the gesture of the target being a specific gesture, such as the “peace” gesture, a “thumb-up” gesture, etc. By trigger the UAV 100 to automatically shoot based on a specific shape of the gesture, it is more convenient and interesting, and can reduce labor costs.

In some embodiments, as shown in FIG. 4, determining that the target is in a specific attitude may include determining that the target is in a jumping state. In this embodiment, the automatically shooting of the UAV 100 may be triggered based on the jumping of the target, which improves the fun and convenience of imaging, and can reduce the labor costs. In this embodiment, determining that the target is in the jumping state may include determining that the vertical distance between the target and the UAV 100 meeting a certain condition. It should be noted that, in this embodiment, the vertical distance between the target and the UAV 100 may refer to the vertical distance between the top of the target and the UAV 100. Further, the camera may include three imaging modes of overhead imaging, horizontal imaging, and vertical imaging. When the camera is in overhead imaging, when the distance between the target and the UAV 100 in the vertical direction decreases instantaneously or continuously, and the target has a changing speed in the vertical direction, the target may be determined to be in the jumping state. When the camera is in horizontal or vertical imaging, when the distance between the target and the UAV 100 in the vertical direction increases instantaneously or continuously, and the target has a changing speed in the vertical direction, the target may be determined to be in the jumping state.

In some embodiments, determining that the target is in a specific attitude may include determining that the target is in a stretched state (this embodiment mainly refers to the limbs of the human body being in an extended state). The UAV 100 may be triggered to shoot automatically based on the stretching of the target, which improves the fun and convenience of imaging, and can reduce the labor costs. The method of triggering the UAV 100 to shoot automatically based on the stretching of the target is suitable for camera in overhead imaging. In this embodiment, before determining that the number of targets in the specific attitude in the cluster is greater than or equal to the predetermined number, the method may further include controlling the UAV 100 to be positioned directly above the cluster, and controlling the camera to shoot downward, such that the camera may perform overhead imaging.

Further, determining that at least a part of the targets in the cluster are in the stretched state may include obtaining joint position of the targets in the imaging frame based on a human joint model; and determining that the target is in the stretched state based on the position of the joints of the target in the imaging frame. This embodiment is based on deep learning technology to obtain a joint body joint model. More specifically, a large number of targets may be collected, and based on the deep learning technology, a large number of collected target images may be classified, and a human body joint model may be trained. In this embodiment, deep learning technology is used to train a human body joint model, and whether the target is in the stretched state can be determined based on the human joint model, and the identification result is highly accurate. Of course, other methods may also be used to identify whether the target is in the stretched state, and it is not limited to the deep learning technology of this embodiment. Furthermore, determining that the target is in the stretched state based on the position of the joints of the target may include determining that the target is in the stretched state based on the positional relationship between at least one of the elbow joint, wrist joint, knee joint, and ankle joint of the target and the trunk of the target.

In some embodiments, determining at least a part of the targets in the cluster are in the specific attitude include determining at least a part of the targets in the cluster are in an unusual attitude. Based on the special attitude of the targets to trigger the UAV 100 to shoot automatically, it can improve the fun and convenience of imaging, and can reduce the labor costs.

In this embodiment, determining at least a part of the targets in the cluster are in the unusual attitude may include determining at least a part of the targets in the cluster are in the unusual attitude based on a usual attitude model. This embodiment is based on deep learning technology to train a usual attitude model. More specifically, a large number of target images in the unusual attitude may be collected, and based on the deep learning technology, a large number of collected target images may be classified, and an unusual attitude model may be trained. In this embodiment, deep learning technology is used to train a unusual attitude model, and whether the target is in the unusual attitude can be determined based on the unusual attitude model, and the identification result is highly accurate. Of course, other methods may also be used to identify whether the target is in the unusual attitude, and it is not limited to the deep learning technology of this embodiment.

In some embodiments, determining a plurality of targets meeting the imaging trigger condition may further include determining that the average speed of the cluster is less than a predetermined speed threshold. It should be noted that, in this embodiment, the average speed of the cluster may refer to the average speed of all targets in the cluster. In an ideal situation, when the speed of all targets in the cluster reaches 0, the camera carried by the UAV 100 is triggered to shoot. However, in reality, it is difficult for all the targets in the cluster to be absolutely still. Therefore, in this embodiment, when the average speed of the cluster is less than the predetermined speed threshold, the cluster can be considered to be stationary. In some embodiments, the predetermined speed threshold may be set based on the clarity of the imaging picture or other requirements.

Further, in the process at S203, triggering the camera carried by the UAV 100 to capture an image may include determining a focus distance of the camera based on a predetermined strategy. When taking a group photo, since the focus and exposure of the camera are biased, for multiple targets, there may only be some targets suitable for focusing or exposure. Therefore, the focus distance of the camera may be determined based on the predetermined strategy, which can filter the targets suitable for focusing or exposure among multiple targets to meet the imaging needs. The method of determining the focus distance of the camera may be set based on the imaging needs. For example, in some embodiments, the focus distance of the camera may be determined by determining the target in the cluster closest to the camera based on the cluster in the current shooting frame, and the horizontal distance between the closest target and the camera, thereby realizing the focusing and exposing of the target closest to the camera. In some embodiments, the target in the cluster that is closest to the camera may be determined based on the size of each target in the cluster. More specifically, the bounding box of each target in the cluster in the current imaging frame may be determined based on image recognition, and the target in the cluster closest to the camera may be determined based on the size of the bounding box of each target. In some embodiments, the target closest to the camera in the cluster may be determined on a depth map corresponding to the current imaging frame.

In other embodiments, the focus distance of the camera may be determined by, calculating an appearance value of each target in the cluster based on an appearance calculation algorithm, and the horizontal distance between the target with the highest appearance value and the camera, thereby focusing and exposing the targets with high appearance value. In some embodiments, the appearance calculation algorithm may use the conventional appearance calculation algorithm.

In some other embodiments, the focus distance of the camera may be determined based on the horizontal distance between a specific target in the cluster and the camera, thereby focusing and exposing the specific target. The specific target in this embodiment may be the first target in the cluster captured by the camera after the UAV 100 is powered on, or it may be the gesture controller of the UAV 100. For details, reference may be made to the description of the specific target in the process at S202, which will not be repeated here.

The imaging method of the camera may also be set as needed. For example, the camera may be set to slow motion shooting to obtain an imaging picture similar to bullet time.

In the embodiments of the present disclosure, by setting the group photo mode on the UAV 100, when multiple targets in the imaging frame meet the imaging trigger condition, the UAV 100 can automatically trigger to camera to shoot, thereby obtaining group photos with multiple targets and realizing automatic shooting of group photos. The imaging process is convenient, the imaging efficiency is improved, and the labor costs are reduced.

In some embodiments, as shown in FIG. 5, after the process at S203, the method further includes the following processes.

S501, controlling the UAV 100 to fly to a specific position based on the cluster in the current imaging frame.

In the process at S501, the specific position may be the next position relative to the current position of the UAV 100.

The setting method of the specific position may be selected based on needs. For example, in some embodiments, the specific position may be located within the obstacle avoidance field of view when the UAV 100 is in the current position. For example, the observation range of a binocular field of view (FOV) may be 30° up and down, and 60° left to right. The connection line between the specific position and the UAV 100 at the current time needs to be controlled to be in the observation range of the binocular FOV to ensure the safety of the UAV 100.

In some embodiments, the specific position may be an experienced classic position, for example, the specific position may be three meters high and inclined at 45° relative to the target, or ten meters high and inclined at 70° degree relative to the target. In some embodiments, the position relative to the target at three meters high and inclined at 45° may be set as a first specific position, and the position relative to the target at ten meters high and inclined at 70° degree may be set as a second specific position, where the first specific position may be the previous position of the second specific position.

In some embodiments, in order to obtain a three-dimensional (3D) image of a cluster, a specific position may be selected as a position at the same height and at a different angle relative to the cluster.

In order to achieve different imaging effects, the process at S501 may also be implemented in different manners. For example, in some embodiment, the process at S501 may include controlling the UAV 100 to fly on a flight plane to a specific position, where the flight plane may be perpendicular to the horizontal plane, the connection line between the current position of the UAV 100 and the cluster may be on the flight plane, and the specific position may be on the flight plane. Further, in some embodiments, the UAV 100 may be preset with a distance of the UAV 100 relative to the cluster when the UAV 100 is in the specific position in the group photo mode, and the method may further include satisfying the imaging needs based on the distance of the UAV 100 relative to the cluster on the flight plane. In other embodiments, the UAV 100 may be preset with an area occupied by the cluster in the imaging frame when the UAV 100 is in the specific position in group photo mode, and the method may further include flying to the specific position on the flight plane based on the area occupied by the cluster in the imaging frame to satisfy the imaging needs.

In some embodiment, the process at S501 may include controlling the UAV 100 to fly around the cluster with a specific radius at a specific height by taking the center of the cluster as the center of the circle; and setting a designated position during the circling flight of the UAV 100 as the specific position. In some embodiments, the UAV 100 may be controlled to fly around the cluster with a specific radius at a specific height by taking the center of the cluster as the center of the circle. In some embodiments, the UAV 100 may be controlled to fly an arc segment around the cluster with a specific radius at a specific height by taking the center of the cluster as the center of the circle. The designated position may be the front, two sides, back, and other positions of the specific target in the cluster, which can be specifically selected as needed. Further, the specific height and the specific radius may also be set based on the imaging needs. For example, in one embodiment, the specific height and the specific radius may be the height of the UAV 100 and the distance from the cluster, respectively, when the UAV 100 enters the group photo mode. In another embodiment, the specific height and the specific radius may be predetermined default values, or may be input in advance by the user.

S502, triggering the camera carried by the UAV 100 to shoot again.

After the process at S502 is performed, a plurality of images captured for the same cluster can be obtained. In some embodiments, for the method of triggering the camera carried by the UAV 100 to shoot, reference may be made to the description of the process at S203, which will not be repeated here.

For example, three group photos need to be taken for a certain cluster. The coordinates of the specific positions may respectively be (x1, y1, z1), (x2, y2, z2), and (x3, y3, z3). In the navigation coordinate system, when the UAV 100 enters the group photo mode based on the trigger instruction, the yaw angle relative to the cluster may be a, the distance relative to the target cluster may be d, and the calculation formulas for the coordinates of the specific position may be as follow:

xᵢ=sin(a)*x_{g}+cos(a)*y_{g};

yᵢ=sin(a)*x_{g}+cos(a)*y_{g};

zᵢ=z_{g}+cos(60°)*d;

where i=1, 2, or 3, and (x_{g}, y_{g}, z_{g}) are the real-time coordinates of the cluster.

In some embodiments, the first specific position may be a certain position 60° diagonally above the cluster, and the distance from the position to the cluster may still be the distance and direction when the UAV 100 enters the group photo mode based on the trigger instruction.

After obtaining the specific positions, PID control may be performed on each of the three directions of x, y, and z to control the UAV 100 to reach the three specific positons in sequence.

In this embodiment, after the process of S502, the method may further include the following process of obtaining images obtained by the UAV 100 on at least two positions; and generating a 3D image of the cluster based on the images obtained by the UAV 100 on at least two positions. In some embodiments, the cluster in the image obtained on at least two positions may partially overlap, thereby achieving the 3D composition of the cluster.

Further, UAV 100 may be preset with at least two scene modes, such as a mountain scene mode, a plain scene mode, and a modular ocean scene mode. In some embodiments, corresponding specific positions may be preset in different scene modes. In order to adapt to different scene modes and obtain more professional images, before the process at S502, the method may further include determining the specific position corresponding to the scene mode based on the currently set scene mode.

In addition, before triggering the camera carried by the UAV 100 to shoot, the method may further include adjusting the imaging angle of the camera carried by the UAV 100 based on the cluster the current imaging frame to meet the imaging needs. In some embodiments, the camera imaging angle may be set in advance by the user, or based on the composition. In this embodiment, the best imaging angle of the camera may be set based on composition, and the composition strategy may be set as needed. For example, in one embodiment, the imaging angle of the camera carried by the UAV 100 may be adjusted based on an expected position of the cluster in the imaging frame. The expected position may be a position where the center point of the cluster is ⅓ pixel height from the bottom of the imaging frame (⅓ pixel height refers to ⅓ of the height of imaging frame expressed in pixels), a position where the distance between the center point of the cluster and a certain position of the imaging frame is a predetermined distance, or a position where the distance between another position of the cluster and a certain position of the imaging frame is the predetermined distance.

Of course, in other embodiments, other composition strategies may also be used to adjust the imaging angle of the camera carried by the UAV 100 to meet the actual imaging needs. For example, by dividing the scene of the imaging frame, the cluster may be placed at a certain position relative to the scene, or by dividing the scene of the imaging frame, the cluster may be placed at a certain ratio relative to the scene, etc. In this embodiment, the scene of the imaging frame may be divided based on deep learning.

Further, before triggering the camera carried by the UAV 100 to shoot, the method may further include controlling the UAV 100 to stay in the current position for a predetermined period of time to ensure that the UAV 100 is stabilized before controlling the camera to shoot to obtain high quality images. The duration of the predetermined period of time in this embodiment may be set as needed, for example, it may be one second, two seconds, or another duration.

In the embodiments of the present disclosure, the UAV 100 may have an automatic position reset function. More specifically, after triggering the camera carried by the UAV 100 to shoot, the method may further include controlling the UAV 100 to return to the position when the cluster was first captured in response to determining that the number of images captured by the camera has reached a predetermined number of images. In some embodiments, the predetermined number of images may be set in advance by the user.

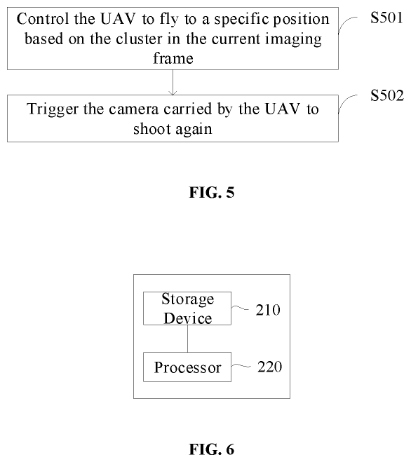

FIG. 6 shows a device for taking group photo consistent with embodiments of the present disclosure. As shown in FIG. 6, the device includes a storage device 210 and a processor 220.

The storage device 210 may include a volatile memory, such as random-access memory (RAM). The storage device 210 may also include a non-volatile memory, such as a flash memory, a hard disk drive (HDD), or a solid-state drive (SSD). The storage device 210 may also include a combination of the above types of memory. Further, the storage device 210 may include computer storage medium that may include one or more of the above types of memory.

The processor 220 may be a central processing unit (CPU). The processor 220 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), a general array logic (GAL), or any combination thereof.

In some embodiments, the storage device 210 may be configured to store executable program instructions in the computer storage medium. The processor 220 may execute the program instructions to implement a method consistent with the disclosure, such as one of the example methods described above in connection with FIGS. 2, 3, and 5.

The processor 220 may execute the program instructions. When executed by the processor 220, the program instructions can cause the processor 220 to enter the group photo mode based on the trigger instruction; identify a plurality of targets in the current imaging frame in the group photo mode; and trigger the camera carried by the UAV 100 to shoot in response to determining a plurality of the targets meeting the imaging trigger condition.

In one embodiment, the processor 220 may be configured to identify the cluster in the current imaging frame based on image recognition and clustering algorithm.

In one embodiment, the cluster may be the cluster where the specific target is located. The specific target may be the first target in the cluster captured by the camera after the UAV 100 is powered on, or the specific target may be the gesture controller of the UAV 100.

In one embodiment, processor 220 determining that a plurality of the targets meeting the imaging trigger condition may include determining that the number of targets in a specific attitude in the cluster is greater than or equal to a predetermined number, or determining that a ratio of the number of target in the specific attitude in the cluster to the total number of targets is larger than a predetermined ratio.

In one embodiment, the processor 220 determining that the target is in a specific attitude may include determining that a gesture of the target is a specific shape.

In one embodiment, the processor 220 determining that the target is in a specific attitude may include determining that the target is in a jumping state.

In one embodiment, the processor 220 determining that the target is in a jumping state may include determining that a change in the vertical distance between the target and the UAV 100 satisfies a specific condition.

In one embodiment, the processor 220 determining that the target is in a specific attitude may include determining that the target is in a stretched state.

In some embodiments, before determining that a plurality of the targets meeting the imaging trigger condition, the processor 220 may be further configured to control the UAV 100 to be positioned above the cluster, and control the camera to shoot downwards.

In one embodiment, the UAV 100 may be configured to obtain the joint positions of the target in the imaging frame based on the human body joint mode, and determine that the target is in the stretched state based on the joint positions of the target in the imaging frame.

In one embodiment, the processor 220 may be configured to determine that the target is in the stretched state based on the positional relationship between at least one of the elbow joint, wrist joint, knee joint, and ankle of the target and the trunk of the target.

In one embodiment, the processor 220 determining that at least a part of the targets in the cluster are in the specific attitude may include determining that at least a part of the targets in the cluster are in an unusual attitude.

In one embodiment, the processor 220 may be configured to determine that at least a part of the targets in the cluster are in an unusual attitude based on a usual attitude model.

In one embodiment, the processor 220 determining that a plurality of the targets meeting the imaging trigger condition may further include determining that the average speed of the cluster is less than a predetermined speed threshold.

In one embodiment, when determining that a plurality of the targets meet the imaging trigger condition and after triggering the camera carried by the UAV 100 to shoot, the processor 220 may be further configured to control the UAV 100 to fly to a specific position based on the cluster in the current imaging frame; and trigger the camera carried by the UAV 100 to shoot again.

In one embodiment, the specific position may be located with the obstacle avoidance field of view of the UAV 100 at the current position.

In some embodiments, the processor 220 controlling the UAV 100 to fly to a specific position based on the cluster in the current imaging frame may include controlling the UAV 100 to fly on a flight plane to a specific position, where the flight plane may be perpendicular to the horizontal plane, the line connecting the current position of the UAV 100 and the cluster may be locate on the flight plane, and specific position may be located on the flight plane.

In one embodiment, the UAV 100 may be preset with the distance of the UAV 100 relative to the cluster or the area occupied by the cluster in the imaging frame when the UAV 100 is in the specific position in the group photo imaging mode, and the processor 220 may be further configured to fly on the flight plane to a specific position based on the distance of the UAV 100 relative to the cluster or the area occupied by the cluster in the imaging frame.

In one embodiment, the processor 220 may be configured to use the center of the cluster as the center of the circle to control the UAV 100 to fly around the cluster with a specific radius at a specific height, and set a designated position during the flight of the UAV 100 as the specific position.

In one embodiment, the specific height and the specific radius may be the height of the UAV 100 and the distance from the cluster, respectively, when the UAV 100 enters the group photo mode.

In one embodiment, after triggering the camera carried by the UAV 100 to shoot again, the processor 220 may be further configured to obtain images obtained by the UAV 100 on at least two positions, where the cluster in the images obtained on the at least two positions at least partially overlap; and generate a 3D image of the cluster based on the images obtained by the UAV 100 on the at least two positions.

In one embodiment, the UAV 100 may be preset with at least two scene modes, and different scene modes may be respectively preset with corresponding specific positions. Before controlling the UAV 100 to fly to a specific position based on the cluster in the current imaging frame, the processor 220 may be further configured to determine the specific position corresponding to the scene mode based on the current set scene mode.

In one embodiment, before trigger the camera carried by the UAV 100 to shoot, the processor 220 may further adjust the imaging angle of the camera carried by the UAV 100 based on the cluster in the current imaging frame.

In one embodiment, the processor 220 may be configured to adjust eh imaging angle of the camera carried by the UAV 100 based on the expected position of the cluster in the imaging frame.

In one embodiment, the expected position may refer to the position where the center point of the cluster is ⅓ pixel height from the bottom of the imaging frame.

In one embodiment, after triggering the camera carried by the UAV 100 to shoot, the processor 220 may further determine the number of images captured by the camera has reached a predetermined number, and control the UAV 100 to return to the position when the cluster was first captured.

In one embodiment, the processor 220 may be configured to determine the focus distance of the camera based on a predetermined strategy.

In one embodiment, the processor 220 may be configured to determine the closest target in the cluster to the camera based on the cluster in the current imaging frame, and determine the focus distance of the camera based on the horizontal distance between the closest target and the camera.

In one embodiment, the processor 220 may be configured to determine the closest target to the camera in the cluster based on the size of each target in the cluster.

In one embodiment, the processor 220 may be configured to calculate the appearance of each target in the cluster based on the appearance calculation algorithm, and use the distance between the target with the highest appearance value and the camera as the focus distance of the camera.

In one embodiment, the processor 220 may be configured to use the distance between a specific target in the cluster and the camera as the focus distance of the camera.

In one embodiment, the specific target may be the first target in the cluster captured by the camera after the UAV 100 is powered on, or the specific target may be the gesture controller of the UAV 100.

For the specific implementation of the processor 220 in the embodiments of the present disclosure, reference may be made to the description of the corresponding content in the foregoing embodiments, which will not be repeated here.

An embodiment of the present disclosure further provides a computer-readable storage medium. The computer-readable storage medium may be configured to store program instructions. When the program instructions are executed by the processor 220, the method for taking group photo of the foregoing embodiment may be implemented.

A person having ordinary skills in the art can appreciate that all or part of the above embodiments may be realized through hardware related to corresponding the computer program. The computer program may be stored in a non-transitory computer-readable medium. When the program is executed by a processor, steps of the above embodiments of the disclosed method may be performed. The storage medium may include a magnetic disk, an optical disk, a read-only memory (“ROM”), a random access memory (“RAM”), etc.

The above embodiments are only examples of the present disclosure, and do not limit the scope of the present disclosure. Although the technical solutions of the present disclosure are explained with reference to the above-described various embodiments, a person having ordinary skills in the art can understand that the various embodiments of the technical solutions may be modified, or some or all of the technical features of the various embodiments may be equivalently replaced. Such modifications or replacement do not render the spirit of the technical solutions falling out of the scope of the various embodiments of the technical solutions of the present disclosure.

What is claimed is:

1. A method for taking group photo comprising:
entering a group photo mode based on a trigger instruction;
identifying a plurality of targets in a current imaging frame in the group photo mode; and
triggering a camera carried by an unmanned aerial vehicle (UAV) to shoot in response to determining a plurality of condition satisfying targets among the plurality of targets, the plurality of condition satisfying targets being ones of the plurality of targets that meet an imaging trigger condition.

2. The method of claim 1, wherein identifying the plurality of targets in the current imaging frame includes identifying a cluster in the current imaging frame based on image recognition and a clustering algorithm.

3. The method of claim 2, wherein:
the cluster includes a specific target; and
the specific target is:
a first target in the cluster captured by the camera after the UAV is powered on, or
a gesture controller of the UAV.

4. The method of claim 2, wherein determining the plurality of condition satisfying targets includes:
determining a number of targets in a specific attitude in the cluster being greater than or equal to a predetermined number; or
determining a ratio of the number of targets in the specific attitude in the cluster to a total number of the plurality of targets being greater than a predetermined ratio.

5. The method of claim 4, wherein determining a target being in the specific attitude includes determining a gesture of the target being a specific shape.

6. The method of claim 2, further comprising, after triggering the camera carried to shoot:
controlling the UAV to fly to a specific position based on the cluster in the current imaging frame; and
triggering the camera to shoot again.

7. The method of claim 6, wherein the specific position is within an obstacle avoidance field of view when the UAV is in a current position.

8. The method of claim 6, wherein controlling the UAV to fly to the specific position based on the cluster in the current imaging frame includes controlling the UAV to fly on a flight plane to the specific position, the flight plane being perpendicular to a horizontal plane, a line connecting a current positon of the UAV and the cluster being on the flight plane, and the specific position being on the flight plane.

9. The method of claim 8,
wherein, the UAV is preset with a distance of the UAV relative to the cluster or an area occupied by the cluster in the imaging frame when the UAV is in the specific position in the group photo mode;
the method further comprising:
controlling the UAV to fly on the flight plane to the specific position based on the distance of the UAV relative to the cluster or the area occupied by the cluster in the imaging frame.

10. The method of claim 6, wherein controlling the flight of the UAV based on the cluster in the current imaging frame includes:
controlling the UAV to fly around the cluster with a specific radius at a specific height; and
setting a designated position during the flight of the UAV as the specific position.

11. The method of claim 10, wherein the specific height and the specific radius are a height and a distance from the cluster, respectively, when the UAV enters the group photo mode.

12. The method of claim 6, further comprising, after triggering the camera to shoot again:
obtaining a plurality of images obtained by the UAV in two or more positions, the plurality of images obtained in the two or more positions at least partially overlap; and
generating a three-dimensional image of the cluster based on the plurality of images obtained by the UAV in the two or more positions.

13. The method of claim 6, further comprising, after triggering the camera to shoot:
controlling the UAV to return to a position when the cluster was first captured in response to determining a number of images captured by the UAV reaching a predetermined number.

14. The method of claim 2, wherein triggering the camera to shoot includes determining a focus distance of the camera based on a predetermined strategy.

15. The method of claim 14, wherein determining the focus distance of the camera based on the predetermined strategy includes:
determining a closest target to the camera in the cluster based on the cluster in the current imaging frame; and
determining the focus distance of the camera based on a horizontal distance between the closest target and the camera.

16. The method of claim 14, wherein determining the focus distance of the camera based on the predetermined strategy includes determining a distance between a specific target in the cluster and the camera as the focus distance, the specific target being:
a first target in the cluster captured by the camera after the UAV is powered on, or
a gesture controller of the UAV.

17. A device for taking group photo comprising:
a memory storing program instructions; and
a processor configured to execute the program instructions to:
enter a group photo mode based on a trigger instruction;
identify a plurality of targets in a current imaging frame in the group photo mode; and
trigger a camera carried by an unmanned aerial vehicle (UAV) to shoot in response to determining a plurality of condition satisfying targets among the plurality of targets, the plurality of condition satisfying targets being ones of the plurality of targets that meet an imaging trigger condition.

18. The device of claim 17, wherein the processor is further configured to execute the program instructions to identify a cluster in the current imaging frame based on image recognition and a clustering algorithm.

19. The device of claim 18, wherein:
the cluster includes a specific target; and
the specific target is:
a first target in the cluster captured by the camera after the UAV is powered on, or
a gesture controller of the UAV.

20. The device of claim 18, wherein the processor is further configured to execute the program instructions to determine the plurality of condition satisfying targets by:
determining a number of targets in a specific attitude in the cluster being greater than or equal to a predetermined number; or
determining a ratio of the number of targets in the specific attitude in the cluster to a total number of targets being greater than a predetermined ratio.
